(19) United States
(12) Patent Application Publication
(10) Pub. No.: US 2006/0247003 A1
(43) Pub. Date: Nov. 2, 2006

(54) Secondary game play advanced by play of primary game

(76) Inventor: Michael Mayo Macke, Duluth, GA (US)

Correspondence Address: Neil S. Goldstein;Cadillac Jack, Inc., 2420 Meadowbrook Parkway, Duluth, GA, 30096, US

(21) Appl. No.: 11/395,445

(22) Filed: Mar. 31, 2006

Related U.S. Application Data
(60) Provisional application No. 60/670,449, filed on Apr. 12, 2005.

(51) Int. Cl. A63F 13/00

(52) U.S. Cl. 463/20

(57) ABSTRACT

Systems and methods for advancing play of a secondary game through play of a primary game in which one or more primary gaming machines are networked to a common gaming machine. The secondary game resides on the common gaming machine and is in a state of continuous play, which does not progress until input is received from one of the primary gaming machines as the result of a triggering event. If the triggering event advances the secondary game to a winning state, the player of the primary game associated with the winning state of the secondary game receives an award.

### CROSS-REFERENCE TO RELATED APPLICATIONS

This application claims the benefit of priority to U.S. provisional patent application Ser. No. 60/670,449 entitled Secondary Game Play via Common Display, which was filed in the United States Patent and Trademark Office on Apr. 12, 2005, the specification of which is hereby incorporated by reference.

### FIELD OF THE INVENTION

The present invention relates to electronic gaming machines and, more particularly, to an apparatus and method for playing a primary game on one or more individual video gaming machines, the results of which serve to advance play of a secondary game displayed on a common display.

### BACKGROUND OF THE INVENTION

Gaming machines such as mechanically driven slot machines have been a staple of the gaming and entertainment industries for years. With the advent of computers, electronic forms of gaming machines such as video slots, video bingo, video poker, video keno and video blackjack have emerged and become increasingly popular. Such electronic devices continue to grow in popularity with the development of enhanced computer-generated graphics and sounds, making them more attractive to a wider audience of participants.

With the recent growth in the electronic gaming machine market, competition between manufacturers to place their equipment in available venues has become fierce. When selecting which machines to put into their facilities, the operators of gaming establishments give paramount consideration to their patrons' perception of a game as entertaining and exciting. To this end, manufacturers and designers of video gaming machines have recently added secondary or bonus games to the base game which are typically triggered by an event during base game play. For example, in a video slot machine, a certain alignment of symbols may take the player to a bonus round where he or she can select one of several race cars appearing on a track. After the selection has been made, a computer generated race is displayed on the display screen. Depending upon the position the selected race finishes, the player is given a bonus such as a cash payout or additional game credits. Such bonus game plays are exciting to the player because the player is provided with a new level of competition that is not part of the base game.

The problem with such approaches is that they are inefficient in attracting first-time players who visit gaming establishments and retaining such players after they have used the games. Traditionally, such attraction and retention is achieved by exposing players and potential players to the game being played on a particular game device. Systems in which each game is played on an individual gaming machine, however, are limited in their effectiveness to attract and retain players as only a relatively small number of spectators can stand in front of the gaming machine and view the display of the game as it is being played. Likewise, the small size of the display makes it less likely that a passerby will take notice of the game and decide to either watch or participate. Such limitations can not only fail to attract new players to the game, but can also lessen the effectiveness of retaining current players, as the current players' motivation and enthusiasm is influenced by the presence and encouragement of a larger group of spectators such as family, friends, or competitors.

Certain systems have attempted to overcome these shortcomings by providing networked gaming machines functionality with a secondary or bonus game displayed on a large screen. For instance, U.S. Pat. No. 6,375,567 discloses a system where a group of primary gaming machines is interconnected by a network and a primary game is played on each. When an operating parameter of one of the gaming machines reaches a threshold value (e.g., total coins played) a secondary game is initiated for the gaming machine responsible for the threshold value being reached. The secondary game is displayed on a second screen above the gaming machines and is common to the group of gaming machines. In the embodiment disclosed in U.S. Pat. No. 6,375,567 the primary game is a slot machine and the secondary game is a spinning wheel. In this prior art system, however, once the secondary game is initiated, the secondary game is played to completion independent of the primary game. Further, only a player (or players) of a primary gaming machine that triggered play of a secondary game are eligible to be awarded a bonus based upon the outcome of that secondary game. The remaining players are not eligible to compete in or be rewarded by the play of the secondary game, thus reducing the role of the other players to mere spectators. These players must await the conclusion of the secondary game, continue playing the primary game until one of them is responsible for the triggering event, allowing that person a chance to compete in the secondary game, while the others must wait and hope for the next opportunity to satisfy a particular threshold value associated with their respective gaming machine for a chance at playing the secondary game.

Such approaches are of minimal effectiveness to entice spectators to initiate play of the primary game given the limited opportunities they have to play the secondary (or bonus) game, nor is it effective to entice players of the primary game to continue play for an extended period of time due to the limited opportunities they have to play the secondary game. Accordingly, there is a need in the art for new approaches to attract and retain players of gaming machines.

### SUMMARY OF THE INVENTION

The present invention relates to systems and methods for advancing play of a secondary game through play of a primary game in which one or more primary gaming machines are networked to a common gaming machine. The secondary game resides on the common gaming machine and is in a state of continuous play, which does not progress until input is received from one of the primary gaming machines as the result of a triggering event. If the triggering event advances the secondary game to a winning state, the player of the primary game associated with the winning state of the secondary game receives an award.

According to an embodiment of the present invention, there is disclosed a gaming machine system for advancing play of a secondary game through play of a primary game which includes at least one primary gaming machine having a primary display and at least one primary game. The primary game is displayed on the primary display and is associated with certain triggering events. A common gaming machine is in communication with the primary gaming machine over a network. The common gaming machine has a common display remotely located from the primary gaming machine upon which game events associated with the secondary game are displayed. Upon the detection of a triggering event resulting from play of the primary gaming machine, a gaming event associated with the secondary game is displayed on the common display and play of the secondary game is advanced by a single step. If the triggering event advances the secondary game to a winning state, an award is provided to the primary gaming machine associated with the winning state.

In another embodiment of the present invention, the primary game and the secondary game are displayed simultaneously.

In yet another embodiment of the present invention, the winning state is associated with an award selected from the group consisting of extra game credits, a bonus spin and extra entries in a progressive jackpot.

In yet another embodiment of the present invention, the common display is a large screen monitor.

In yet another embodiment of the present invention, the primary game played on the primary gaming machine is selected from the group consisting of video bingo, video blackjack, video poker, video keno and video slots.

In yet another embodiment of the present invention, the secondary game displayed on the common display is selected from the group consisting of video bingo, video blackjack, video poker, video keno and video slots.

In yet another embodiment of the present invention, the primary gaming machine has at least one interface that includes a series of electromechanical buttons to control game events.

In yet another embodiment of the present invention, the display of the primary gaming machine includes a touch screen interface for accepting commands to alter events associated with the primary game.

In yet another embodiment of the present invention, the primary gaming machine includes a wager input interface selected from the group consisting of a bill acceptor, a ticket reader and a magnetic card reader.

In yet another embodiment of the present invention, the gaming machine system includes a server in communication with the primary gaming machine, wherein the primary game is stored in a memory location accessible by the server.

In yet another embodiment of the present invention, the gaming machine system includes a server in communication with the primary gaming machine, wherein the detection of the triggering events is performed by the server.

According to another embodiment of the present invention, there is disclosed a method of advancing play of a secondary game through play of a primary game which includes the steps playing a primary game on a primary gaming machine having a primary display upon which the primary game is displayed and is associated with certain triggering events; detecting the occurrence of a triggering event; displaying a game event associated with the secondary game on a common display remotely located from the primary gaming machine and advancing play of the secondary game upon the detection of a triggering event; determining if the triggering events advances the secondary game to a winning state; and awarding an award to the primary gaming machine associated with advancing the secondary game to the winning state.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a block diagram of a primary gaming machine in accordance with an exemplary embodiment of the invention.

FIG. 2 shows an exemplary primary gaming machine for playing an electronic game in accordance with an exemplary embodiment of the invention.

FIG. 3 shows a block diagram of a common gaming machine in accordance with an exemplary embodiment of the invention.

FIG. 4 shows a schematic diagram of a gaming system embodying the principles of an exemplary embodiment of the invention.

FIG. 5 shows an exemplary flowchart of a gaming machine system providing for secondary game play advanced by play of a primary game display in accordance with an exemplary embodiment of the invention.

### DETAILED DESCRIPTION OF THE INVENTION

The present invention is directed to an electronic gaming machine system in which certain triggering events resulting from the play of a primary gaming machine serve to advance play of a secondary game played simultaneously on a common gaming machine that is common to the player or players of the primary game. The system includes one or more primary gaming machines networked to the common gaming machine. In accordance with an exemplary embodiment of the invention, each of the primary gaming machines comprises a cabinet for housing electronic components necessary for operation of game play and the common gaming machine comprises a standard PC and a common display. The common display is located remote from the primary gaming machines and positioned in such a manner as to allow it to be viewed by a large audience of spectators. The secondary game resides on the common gaming machine and is in a state of continuous play, although play does not progress until input is received from one of the primary gaming machines (e.g., a triggering event), which will be discussed in further detail below.

During play of the one or more primary gaming machines, a triggering event, which may vary depending on the primary game being played (e.g., a winning bingo pattern, a certain poker hand, blackjack, etc.) causes the secondary game to progress. For example, where the secondary game is bingo, one or more balls may be called as the result of the triggering event associated with one of the primary gaming machines, which may or may not result in a winning bingo pattern on the secondary game. If the triggering event does not cause the secondary game to advance to a winning state, the secondary game remains idle until the next triggering event received from one of the primary gaming machines. If, however, the triggering event advances the secondary game to a winning state, the player of the primary game responsible for the triggering event receives an award such as extra game credits, a bonus spin or extra entries in a progressive jackpot. In an alternative embodiment of the invention, the player associated with the winning state of the secondary game receives the award, which may be a player other than the one who initiated the triggering event. For example, if the secondary game was Bingo, then the player associated with a winning Bingo pattern receives the award, or if the second game was a car racing game that was advanced by triggering events received from the primary gaming machines, the player associated with the winning car receives the award.

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements.

The present invention is described below with reference to block diagrams and a flowchart according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by special purpose hardware-based computer systems that perform the specified functions or steps, or combinations of special purpose hardware and computer instructions.

The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types or perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network. Exemplary embodiments of the present invention will hereinafter be described with reference to the figures, in which like numerals indicate like elements throughout the several drawings.

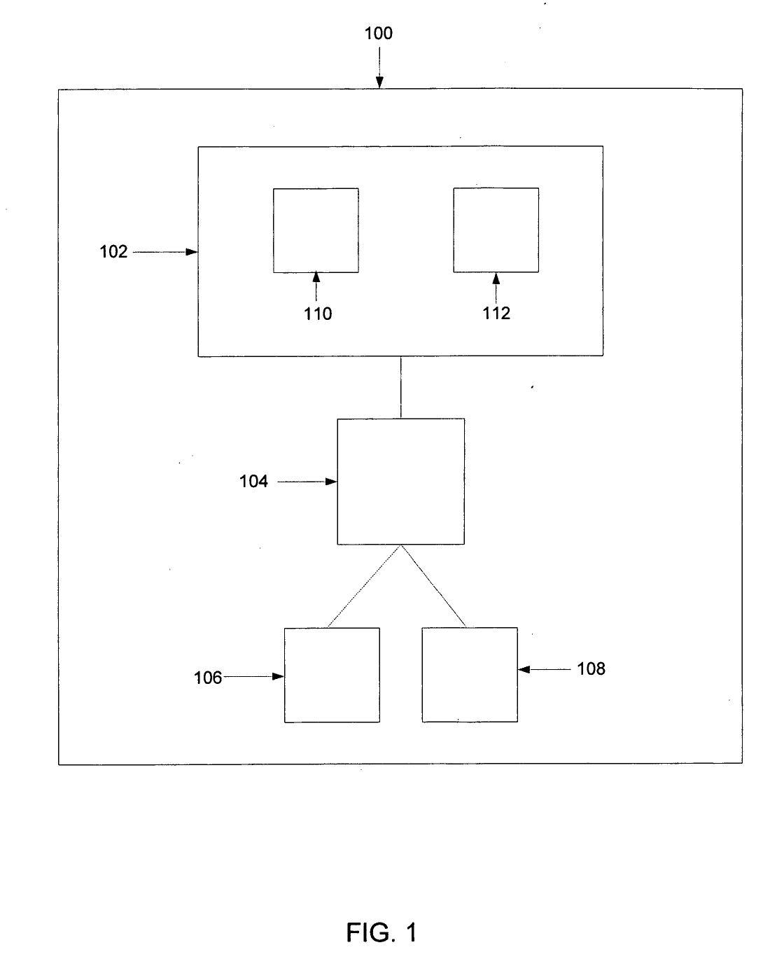

FIG. 1 shows a block diagram of a primary gaming machine 100 for playing a primary game in accordance with the present invention. In the exemplary embodiment of FIG. 1, the primary gaming machine 100 includes various electronic components necessary for operation of the gaming machine 100. These components may include a memory storage device 102 such as a flash memory card or hard drive, a computer processor 104, I/O interfaces 106 and a network interface 108. In one embodiment of the present invention, the various functions of the gaming machine 100 discussed herein are controlled by the processor 104 utilizing various software programs stored in the memory storage device 102. Alternatively, the software programs can reside on a server, as discussed in greater detail below.

The primary gaming machine 100 contains one or more I/O interfaces 106. These interfaces may include a display, touch-screen display, microphones, speakers, buttons, mouse, joystick, a keyboard or other user interfaces appreciable by one of ordinary skill in the art. In an exemplary embodiment of the present invention, the primary gaming machine 100 also includes a wager input interface as part of its I/O interfaces 106 through the use of which a player receives game credits available to wager. In an exemplary embodiment of the present invention, the wager input interface is a bill acceptor into which a player inserts paper currency and receives credit on the primary gaming machine 100 for the amount deposited. In an alternate embodiment of the present invention, the wager input interface is a magnetic card reader into which the player places a plastic card magnetically encoded with a monetary value purchased from a cashier's station or vending machine. In still another alternate embodiment of the present invention, the wager input interface is a ticket reader into which the player places a paper ticket bearing an encoded monetary value into the wager input interface and is credited with the monetary value. The wager input interface may also be a coin slot, credit card reader or other means known in the art. Further, the I/O interfaces 106 may also include printers, coin dispensers, ticket dispenser and other such I/O interfaces appreciated by one of ordinary skill capable of dispensing a player's remaining credits and/or winnings (i.e., “cashing out”).

Also included in the primary gaming machine 100 is a memory storage device 102 where various game data such as winning bingo card patterns or winning poker or blackjack hands and the corresponding pay schedule (i.e., pay tables, which are utilized to determine the value of the awards payable for such patterns or hands) are stored. The memory storage device 102 also stores game software 110 necessary to play a game on the primary gaming machine 100 and an operating system 112 for use by the computer processor 104 in controlling the various functions of the primary gaming machine 100, such as the calling of various software routines and operating various system hardware and interfaces such as the I/O interfaces 106 and network interfaces 108.

The memory storage device 102 resides within the primary gaming machine 100, or, in an alternative embodiment of the present invention, the memory storage device 102 may reside remote from the primary gaming machine 100. For example, the memory storage device 102, and some or all of its stored content, may reside on a central machine or server where two or more primary gaming machines 100 are networked together. In such a case, the gaming machine communicates with the central machine or server through a network interface 108. The network interface 108 allows the primary gaming machine 100 to simply communicate with a transmission portal such as a server or router, and the necessary software program functions could be run remote from the primary gaming machine 100 altogether.

In an exemplary embodiment of the present invention, a user may enter wager information utilizing the I/O interface 106 of the primary gaming machine 100. The wager information is stored in the memory storage device 102. Next, the computer processor 104 utilizes an operating system which in turn calls the game program to run the game on the primary gaming machine 100.

In an exemplary embodiment of the present invention, a number of primary gaming machines 100 may be in communication with to a server through a network. The network can be a dedicated private network including a LAN, WAN, T1 connection, or a public network such as the Internet. The network can also be one which supports any networking protocol including Internet Protocol, FTP, Telnet, TCP/IP, UDP, Point to Point Protocol (PPP), Challenge Handshake Authentication Protocol (CHAP), or other public or private networking protocol. Secured or encrypted network protocols such as secured HTTPS protocol and other secure methods of data transfer over public networks appreciable by one of ordinary skill in the art and/or user ID and password protected log-in security features may also be utilized. In an exemplary embodiment of the present invention, the use of a dedicated server allows the primary gaming machines 100 to be remotely accessed through the Internet or some other network such as a private Intranet, LAN, WAN, T1 connection, or other networking configurations appreciable by one of ordinary skill in the art. The requisite architecture for networking a series of games is well known in the art and is not discussed further herein.

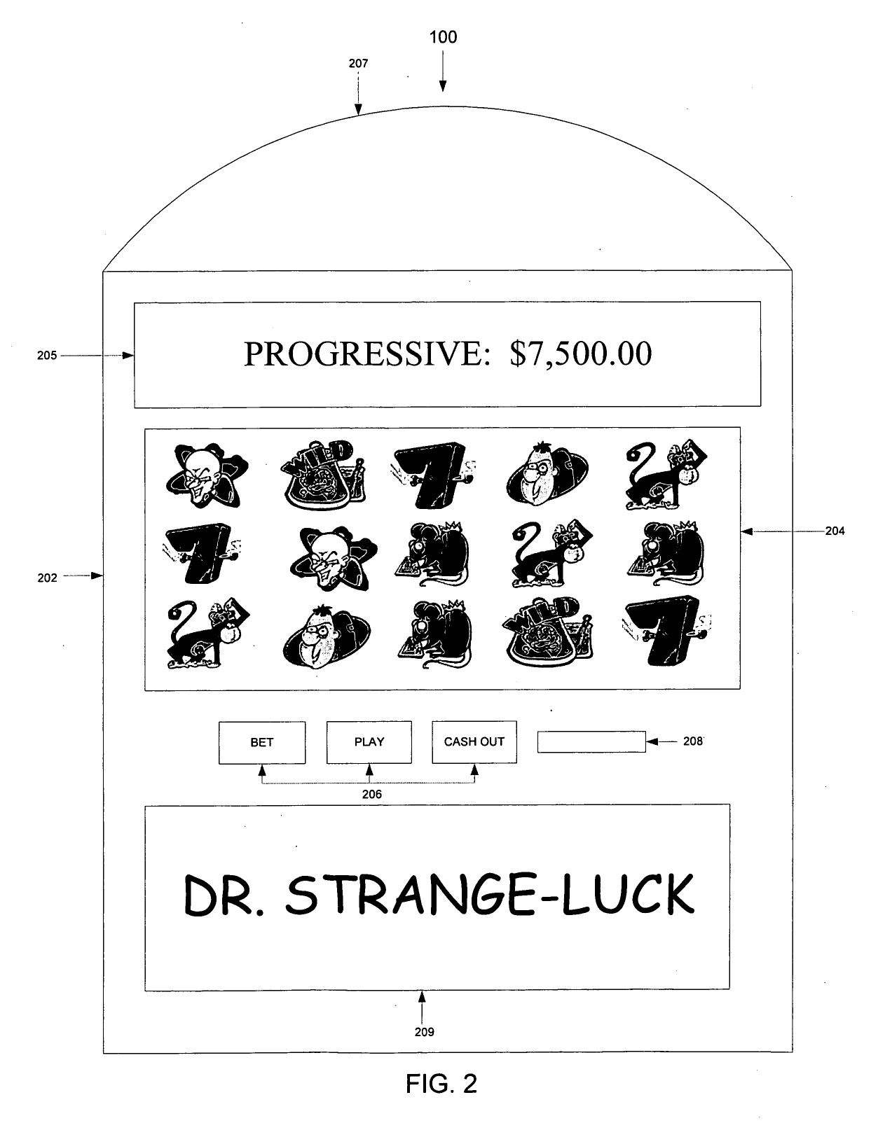

FIG. 2 depicts a primary gaming machine 100 in accordance with one embodiment of the present invention. It is noted that the term “gaming machine” may refer to any device, activity or mode of play for gaming (i.e., gambling or redemption), amusement, competition, or other purposes. Additionally, “gaming machine” may refer to a “stand alone” player station or console in which case the outcome of game play is determined locally or part of a server-based network of gaming machines in which case the outcome of game play is centrally determined. The primary gaming machine 100 includes a cabinet 202 housing a primary display 204 for displaying game events. The primary display 204 may be a mechanical display such as used in traditional slot machines or a video display such as a flat panel LCD as used in electronic games such as video bingo, video slots, video poker, video keno or video blackjack. In one embodiment of the present invention, the primary gaming machine 100 includes a progressive display 205 for displaying the value of any progressive jackpot that may be available in the case where the primary gaming machine 100 is part of a network. The primary gaming machine 100 may also include top glass 207 and belly glass 209 for displaying various information such as game rules or graphics designed to attract players to participate.

Proximate to the primary display 204 are a series of electromechanical buttons 206 positioned on the cabinet for use as a user interface for controlling game play such as selecting a bet amount, commencing play and cashing out. The specific arrangement and function of each of the electromechanical buttons 206 is dependent upon the type of game being played on the primary gaming machine 100. For example, for a blackjack game, the electromechanical buttons 206 may include options for placing a bet, cashing out, hitting or standing, doubling down, purchasing insurance and/or splitting. Alternatively, in a poker game, the electromechanical buttons 206 may include options for placing a bet, cashing out and/or designating which cards to keep and which to discard. In one embodiment of the present invention, the primary display 204 is a “touch screen” upon which icons corresponding to some or all of the electromechanical buttons 206 appear. The user can activate the functions associated with the icons by simply touching the appropriate area of the primary display 204 rather than depressing the electromechanical buttons 206.

In one embodiment of the present invention, the primary gaming machine 100 includes a wager input interface 208, such as a bill acceptor, into which a player inserts paper currency and receives credit for the amount deposited. In alternate embodiments of the present invention, the wager input interface 208 can be a ticket reader or a magnetic card reader into which the player places a ticket or magnetic card encoded with a monetary value purchased from a cashier's station or vending machine.

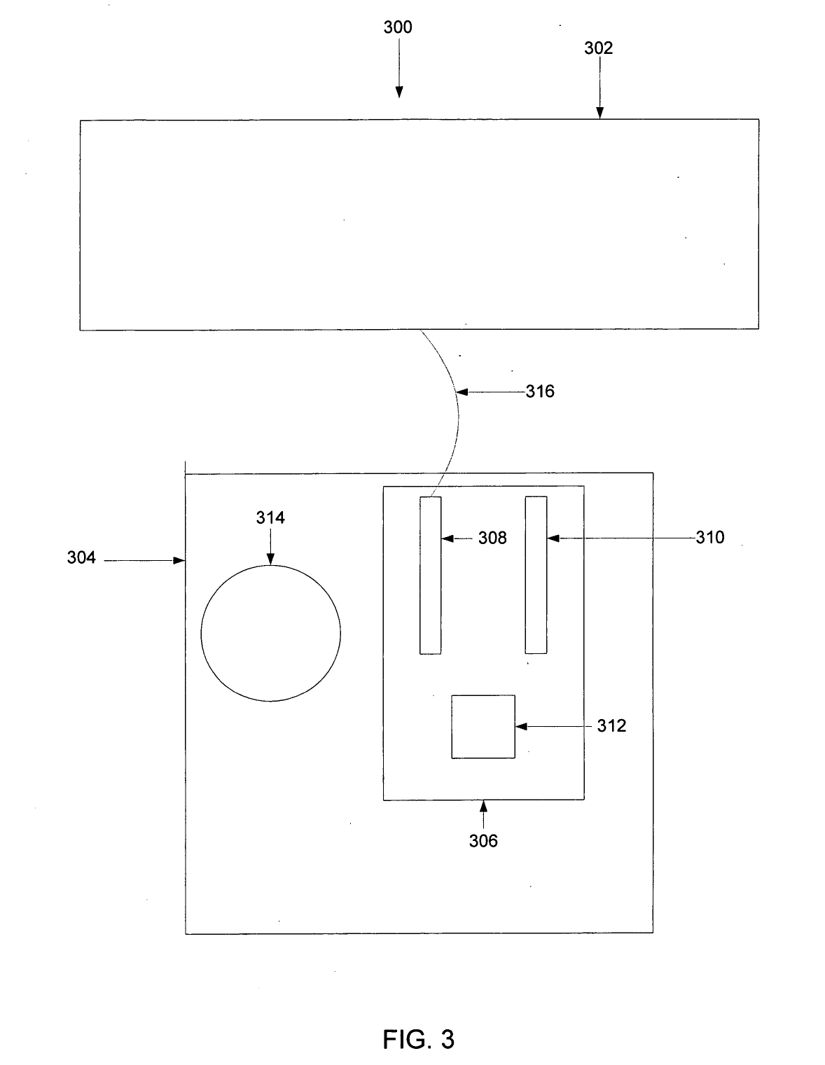

FIG. 3 is a block diagram of the common gaming machine 300 in accordance with the present invention. In an exemplary embodiment, the common gaming machine 300 comprises a common display 302 and a standard PC 304. The PC includes a motherboard 306 having a graphics card 308, a network card 310, a computer processor 312 and a memory storage device 314 such as a flash memory card or hard drive where various game data such as winning bingo card patterns or winning poker or blackjack hands and the corresponding pay schedule (i.e., pay tables, which are utilized to determine the value of the awards payable for such patterns or hands) are stored. The common display 302 is connected to the video output of PC 304 via a standard video cable 316. In an exemplary embodiment, the common display 302 is a large screen monitor such as a plasma or liquid crystal display (LCD) monitor. Such monitors may be extremely thin making them particularly suitable for mounting at an elevation above the gaming machines allowing the common display 302 to be viewed by a large audience of individuals. However, the common display 302 could, in the alternative, be a CRT, rear projection monitor, or any other type of display known in the art.

In one embodiment, the various functions of the common gaming machine 300 discussed herein are controlled by the processor 312 utilizing various software programs stored in the memory storage device 314. In an alternative embodiment of the present invention, the memory storage device 314 may reside remote from the common gaming machine 300. For example, the memory storage device 314, and some or all of its stored content, may reside on a central machine or server, in which case the necessary software program functions could be run remote from the common gaming machine 300 altogether.

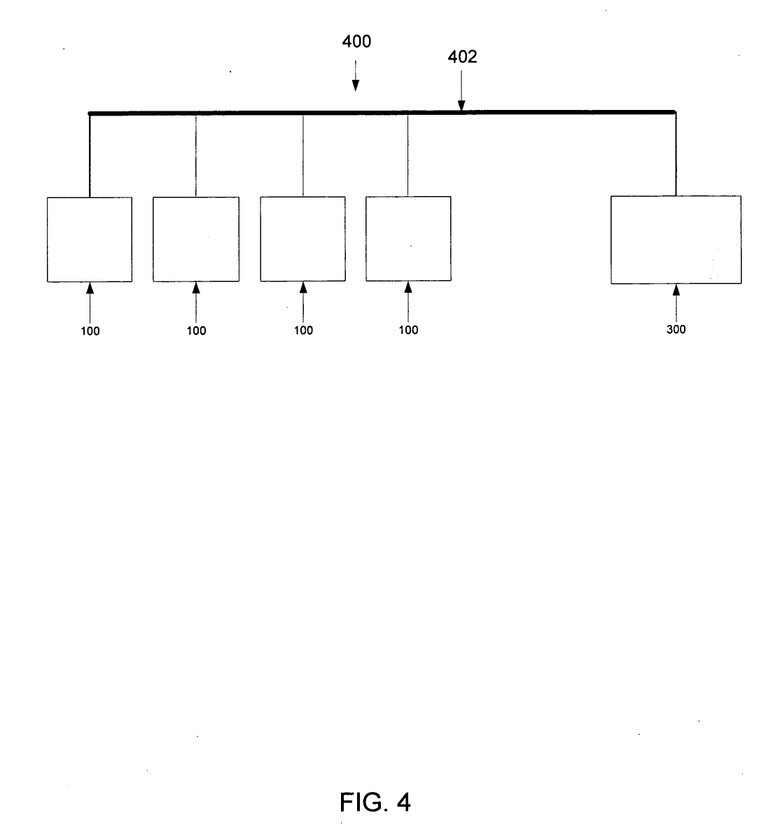

FIG. 4 is a block diagram of a game system 400 providing secondary game play advanced by play of a primary game in accordance with the present invention. The system 400 includes one or more primary gaming machines 100 networked with the common gaming machine 300 through a connection 402, such as an Ethernet connection or the like. Each primary gaming machine 100 may be located locally or remotely with respect to one another.

The games played on each primary gaming machine 100 may be the same or different from one another. For example, the primary games being played on various primary gaming machines 100 networked to one another may each be a poker game or, alternatively, they may be made up of poker, blackjack, bingo, keno and slot games. Similarly, the secondary game played on the common gaming machine 300 may be the same or a different type of game from the games played on the primary gaming machines 100. In another exemplary embodiment of the invention, the primary and secondary games may share a common theme to further entice a player to either initiate or continue play of both games. The common themes may be tied to various motifs such as sports, geographic locations, or pop culture references to movies, television, music, etc. For example, the primary game may be a race car themed electronic slot machine and the secondary game may be a car racing game, where each player is assigned to a car in the secondary game and triggering events from the primary game (e.g., a particular combination of car symbols on a slot pull) advances the race in the secondary game. One of ordinary skill in the art will recognize the various types of games and themes that can be used for primary games and secondary games.

Play of the primary and secondary games is related to one another in that play of the latter is advanced through certain triggering events occurring in the former. A triggering event may be any event or aspect of game play that occurs in the primary game. In other words, when a triggering event associated with the primary game is detected, a game event in the series of game events that make up the secondary game is displayed on the common display. When another triggering event associated with the primary game is detected, the next game event in the series of game events that make up the secondary game is then displayed on the common display. This process repeats until a detected triggering event associated with the primary game causes a game event of the secondary game that is associated with a winning state to be displayed on the common display. In an exemplary embodiment of the invention, the winning state is the end of the secondary game (e.g., a specific bingo pattern being achieved, the end of a race, the last card dealt in a game of Blackjack or Texas Hold'em poker, etc.) At that time, the player who caused the secondary game to enter the winning state receives an award.

For example, the secondary game played on the common gaming machine 300 could be a bingo game and the primary games played on the primary gaming machines 100 could be any combination of poker, blackjack, bingo, keno and slots. In other words, the networked primary gaming machines may all be participating in the same primary game (e.g., the same poker deal), may be each individually be playing the same type of primary game (e.g., each playing a slot machine), or may be each playing different types of primary games (e.g., primary gaming machine 1 is playing blackjack, while primary gaming machine 2 is playing poker). In such a configuration, a bingo card is displayed on the common display 302 of the common gaming machine 300. Typically, the bingo card is a five-by-five matrix, although any combination of rows and columns may be used. A random number generator program stored in memory storage device 314 assigns a number to each square on the bingo card, usually from the range between 1 and 75.

The bingo game on the common display is in a state of continuous play and does not progress until input is received from one or more of the primary gaming machines 100 as the result of a triggering event. Upon such a triggering event occurring in a primary game, the random number generator may cause one or more numbered bingo balls to be “called” in the bingo game on the common display. For example, a Royal Flush obtained in a poker game on a primary display may trigger three bingo balls being called in the bingo game on the common display, a blackjack hand may trigger two bingo balls and/or a winning bingo pattern in a bingo game may trigger one bingo ball. As the bingo balls are called, the processor 312 compares the numbers drawn with the spaces on the bingo cards corresponding to one or more players of the primary gaming machines and marks any matches accordingly. If the triggering event does not produce a winning bingo pattern, the secondary game remains idle until the next triggering event. In the event that a bingo ball call results in one of the winning bingo patterns stored in memory storage device 314, the player associated with the winning bingo pattern may receive an award, and, in certain embodiments of the invention, the player of the primary game responsible for the corresponding triggering event may receive an award as well. Such awards may be in the form of extra game credits, a bonus spin or extra entries in a progressive jackpot. At this point, a new bingo card may be displayed on the common display 302 of common gaming machine 300, ready for play of a new bingo game round. The secondary game remains idle pending the next triggering event.

It should be understood that one of ordinary skill in the art will appreciate how to make and use the foregoing elements of the exemplary game system based on the description herein. Moreover, one of ordinary skill in the art will appreciate that various modifications can be made to the structure and/or substance of the foregoing description.

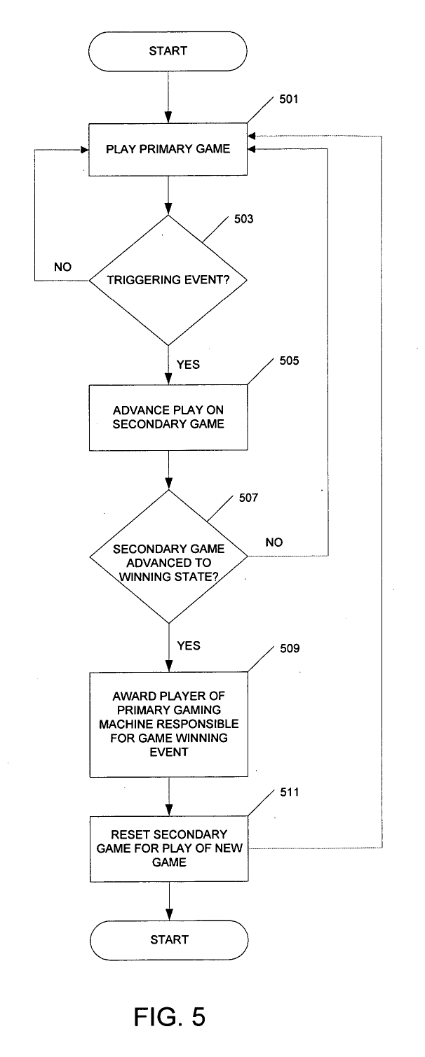

FIG. 5 shows an exemplary flowchart of the various functions of a gaming machine system in accordance with the present invention. As described with reference to FIG. 5, the player invokes step 501 to initiate game play. First, the player places a wager by inputting currency or a ticket or magnetic card bearing game credits into wager input interface 208 of a primary gaming machine 100. In an exemplary embodiment of the present invention, the gaming machine indicates the amount of money or credit available for the player to bet during play. The player then proceeds indicate the amount to be wagered on a particular play of the game, up to the lesser of the available game credits or the maximum allowable bet on the gaming machine. The player starts play of the game by selecting the appropriate choice among the electromechanical buttons 206.

After the placing of a wager and commencing play of the primary gaming machine 100, the player interacts with the game in accordance with step 501. For example, if the game being played on the gaming machine 100 is blackjack, the player is dealt cards and subsequently makes decisions whether to stand, hit, double down, split or purchase insurance. Alternatively, if the game is poker, the player is dealt cards and makes decisions to try to achieve the best hand.

According to step 503, if the play of the game on primary gaming machine 100 results in a triggering event, step 505 is invoked in which play of a secondary game residing on a common gaming machine is advanced. The secondary game resides on the common gaming machine and is in a state of continuous play, although play does not progress until occurrence of a triggering event.

According to step 507, if the triggering event advances play of the secondary game to a winning state, step 509 is invoked in which the player of the gaming machine responsible for triggering the game winning receives an award such as extra game credits, a bonus spin or extra entries in a progressive jackpot. The secondary game is then reset for a new game in accordance with step 511. The gaming machine system then reverts to step 501, advancing play of the secondary game.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A gaming machine system for advancing play of a secondary game through play of a primary game comprising:
at least one primary gaming machine, wherein the at least one primary gaming machine contains a primary display and is associated with at least one primary game, wherein the at least one primary game is displayed on the primary display and is associated with a plurality of triggering events; and
a common gaming machine in communication with the primary gaming machine over a network, wherein the common gaming machine is in communication with a common display remotely located from the at least one primary gaming machine and is associated with a secondary game, wherein the secondary game is displayed on the common display and is associated with a series of game events,
wherein upon the detection of a triggering event of the plurality of triggering events occurring as a result of play of the at least one primary game, a single gaming event in the series of game events associated with the secondary game is displayed on the common display and play of the secondary game is advanced by a single step, and
wherein upon the detection of a triggering event of the plurality of triggering events occurring as a result of continued play of the at least one primary game that results in the play of the secondary game being advanced to a winning state, an award is presented to the gaming machine responsible for advancing the secondary game to the winning state.

2. The system of claim 1, wherein the at least one primary game and the secondary game are displayed simultaneously.

3. The system of claim 1, wherein the winning state is associated with an award selected from the group consisting of extra game credits, a bonus spin and extra entries in a progressive jackpot.

4. The system of claim 1, wherein the common display is a large screen monitor.

5. The system of claim 1, wherein the at least one primary game displayed on the primary display is selected from the group consisting of video bingo, video blackjack, video poker, video keno and video slots.

6. The system of claim 1, wherein the secondary game displayed on the common display is selected from the group consisting of video bingo, video blackjack, video poker, video keno and video slots.

7. The system of claim 1, further comprising at least one interface associated with the primary gaming machine that includes a series of electromechanical buttons to control game events on the primary display of the at least one primary gaming machine.

8. The system of claim 1, further comprising at least one touch screen interface on the primary display of the at least one primary gaming machine, wherein the touch screen interface accepts commands to alter at least one game event associated with the at least one primary game.

9. The system of claim 1, wherein the at least one primary gaming machine further includes a wager input interface selected from the group consisting of a bill acceptor, a ticket reader and a magnetic card reader.

10. The system of claim 1, further comprising a server in communication with the at least one primary gaming machine, wherein the at least one primary game is stored in a memory location accessible by the server.

11. The system of claim 1, further comprising a server in communication with the at least one primary gaming machine, wherein the detection of the triggering events is performed by the server.

12. A method of advancing play of a secondary game through play of a primary game comprising:
playing a primary game on a primary gaming machine having a primary display wherein the primary game is displayed on the primary display and is associated with a plurality of triggering events;
detecting the occurrence of one of the plurality of triggering events;
displaying a game event of a series of game events associated with the secondary game on a common display remotely located from the primary gaming machine and advancing play of the secondary game upon the detection of the one of the plurality of triggering events;
determining that one of the plurality of triggering events advances the secondary game to a winning state; and
awarding the primary gaming machine associated with advancing the secondary game to the winning state an award.

13. The method of claim 12, further comprising simultaneously displaying the primary game on the primary display and the secondary game on the common display.

14. The method of claim 12, wherein the game displayed on the primary display is selected from the group consisting of video bingo, video blackjack, video poker, video keno and video slots.

15. The method of claim 12, further comprising accepting a wager at a primary gaming machine via a wager input interface, wherein the wager input interface is selected from the group consisting of a bill acceptor, a ticket reader and a magnetic card reader.

16. The method of claim 12, wherein the triggering event is selected from the group consisting of a winning bingo pattern, a blackjack hand and a specified poker hand.

17. The method of claim 12, wherein the winning state is associated with an award selected from the group consisting of extra game credits, a bonus spin and extra entries in a progressive jackpot.

18. The method of claim 12, wherein the secondary game displayed on the common display is selected from the group consisting of video bingo, video blackjack, video poker, video keno and video slots.

19. The method of claim 12, wherein the primary game is stored in a memory location accessible by a server in communication with the primary gaming machine.

20. The method of claim 12, wherein detecting the occurrence of one of the plurality of triggering events is performed by a server in communication with the at least one primary gaming machine.
